(19) United States
(12) Patent Application Publication
(10) Pub. No.: US 2009/0235045 A1
(43) Pub. Date: Sep. 17, 2009

(54) EXTENDING THE ADDRESSING SPACE OF RECORD CARRIERS

(75) Inventors: Bart Van Rompaey, Eindhoven (NL); Alexander Padiy, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/720,840

(22) PCT Filed: Nov. 30, 2005
(86) PCT No.: PCT/IB2005/053965

§ 371 Date: Jun. 5, 2007

(30) Foreign Application Priority Data
Dec. 8, 2004 (EP) 04106382.7

(51) Int. Cl. G06F 12/06

(52) U.S. Cl. 711/203; 711/E12.078

(57) ABSTRACT

Current BD specification prescribes the following format for the ADIP: 24 bits, 3 of which to indicate the layer number, 19 for the RUB number, and 2 to be set to 00, 01 and 10 consecutively in the 3 successive ADIP words corresponding to one RUB that is the smallest partition of data that can be written on the disc. From this it derives that at most 32.2 GB of storage space can be addressed. Due to recent developments however, a storage capacity of 35 GB per layer could be achieved. A slight modification of the ADIP format is proposed, so as to allow an extension of the addressing space: the setting 11 for the two least significant bits is allowed, while the 19 bits no longer represent the RUB number. A drive will nevertheless convert the ADIP into a RUB number and vice versa, in a way which is transparent to a host device or application program.

The present invention relates to a drive, such as a recording device or a reproduction/reading device for reading and/or recording user data at a physical sector address on a record carrier, to a corresponding method, and to the record carrier.

The current specifications for Blu-ray Disc rewritable (BD-RE) and write once (BD-R) describe a wobble in the pre-groove containing position information in the form of a bit sequence representing an address, the so-called ADdress In Pre-groove (ADIP). This is comparable to the CD specifications according to which there is an address called Absolute Time in Pre-groove (ATIP). These addresses are needed for allocation purposes on an empty or semi-empty disc.

One ADIP address, in BD-RE as well as in BD-R, consists of 24 bits, numbered ΛΛ23 down to ΛΛ0; the letters ΛΛ stand for physical ΛDIP Λddress. These bits are stored, together with 12 bits of auxiliary data, in the wobble of the pre-groove, and form an ADIP word. Three consecutive ADIP words in the pre-groove have the same physical length as one Recording Unit Block (RUB) in the main data channel, that is a block of information. A RUB is the smallest partition of data, namely 64K, that can be written on the disc.

Currently the following bit assignments have been made for the ADIP words:

| | |
|---|---|
| AA23 . . . AA23: | 3 bits to indicate the layer number; |
| AA22 . . . AA2: | 19 bits, also called real RUB bits, to contain a |
| | sequential number, which number shall increase by |
| | one after each 3 consecutive ADIP words. |
| | (synchronized to the RUBs); |
| AA1, AA0: | 2 bits, also called real ADIP bits, to be set to 00, 01 |
| | and 10 consecutively in the 3 successive ADIP words |
| | corresponding to one RUB. The setting 11 is |
| | reserved and shall not be used; |
| AX11 . . . AX0: | 12 bits to contain auxiliary information about the |
| | disc: in the Inner Zone of the disc the auxiliary bits |
| | shall be used to store a copy of the disc information; |
| | elsewhere on the disc these 12 bits shall be set to zero. |

The current specification for BD-RE and BD-R specifies capacities up to 27 GB. In future higher capacities can occur; for instance, capacities of 38 GB on a BD-RE disc are possible. For such higher capacities more recording addresses are required on a disc. As described above 19 bits are available according to the standard to indicate different recording addresses, and, with these 19 bits only, up to 32.2 GB of data can be addressed. For capacities higher than this not enough positions can be addressed on the disc. This is an important issue since for future multi-layer extensions of BD, 35 GB is thought of as target capacity per layer.

It is an object of the present invention to provide a drive, a corresponding method and an information carrier and the apparatus, by which a larger amount of data can be addressed on a record carrier, while at the same time involving as little as possible changes to the current encoding rules.

According to the invention, the object is achieved by a drive as claimed in claim 1, by a corresponding method for use in the drive as claimed in claim 10, and by a record carrier as claimed in claim 7.

Preferred embodiments of the invention are defined in the dependent claims.

The invention is based on the idea to introduce a virtual address and a step of mapping from said virtual address to the real recording address provided on the record carrier. By the proposed mapping the two real ADIP bits change compared to the current specification in as far as the bit setting 11 will become allowed for these two bits, whereas according to the current specification only the bit settings 00, 01 and 10 are allowed.

The virtual address contains enough bits to identify all the needed RUBs to obtain a capacity larger than 32.2 GB, namely 42.9 GB per layer which is more than sufficient for the upcoming BD standard extensions. It is further ensured that the concept of how to use the physical sector address, used in the current format specification remain the same except that they contain one more bit (or use one more reserved bit). Addressing the disc by an application remains completely the same in this way. This leads to easy acceptance of the proposed solution. The physical organization of the data on the disc remains the same, only the bits put in the fields ΛΛ0 . . . ΛΛ20 of the recording addresses change.

In a preferred embodiment of the invention it is proposed that a recording address word of said recording addresses comprises two real ADIP bits set to 00, 01, 10 or 11 and a predetermined number of real RUB bits containing a sequential number increasing after each four consecutive recording address words. Thus, the real RUB bits are not always increased after each RUB, but due to the allowed bit setting 11 of the two real ADIP bits only after each fourth recording address word the sequential number stored in the real RUB bits is increased. In this way the increase of the addressable storage (recording space) is obtained.

In a further preferred embodiment the virtual address word each comprise 20 virtual RUB bits and the recording address words each comprise 19 real RUB bits. Thus, the length of the recording address words is—compared to the present specification for BD—not changed, while in the virtual address words one more bit is used in addition.

In order to ensure that the concept of use and conversion of the physical sector address into an address unit number and, further, for conversion of the address unit number into a virtual address are not changed substantially, the virtual address determination unit preferably comprises a first and a second subunit for performing said two conversions.

In a preferred embodiment the virtual address is converted into said recording address by multiplying the value of said virtual RUB bits by a factor of three and adding the result to the value of said virtual ADIP bits. However, other ways of mapping the virtual address onto the recording address are possible as well.

The invention is preferably used for recording of user data on a recordable or rewritable record carrier, such as an optical disc. But it can generally be applied as well for reading user data from a record carrier, such as a ROM disc, for instance if the concept of using address in a pre-groove (e.g. embedded in a wobble of the pre-groove) is used on such a record carrier.

Further, the invention can well be applied in a multi-layer record carrier. For addressing the particular layer on which data shall be read or recorded it is further proposed that the physical sector addresses comprise a physical layer number indicator, in particular three layer indicating bits, indicating one of a plurality of recording layers of a multi-layer record carrier, in which said user data shall be recorded or read. Furthermore, the address conversion unit is adapted for converting said physical layer number indicator into a virtual layer number indicator included in said virtual addresses.

An alternative solution to the object, based on the same general inventive concept, is achieved by a drive as defined in claim 11 and a corresponding method as defined in claim 12, said drive comprising:

a) an access unit for reading and/or recording said user data on the record carrier, and
b) an address conversion unit for converting said physical sector address into a recording address used by said access unit for reading and/or recording user data at said recording address on the record carrier, wherein a recording address word of said recording addresses comprises two real ADIP bits set to 00, 01, 10 or 11 and a predetermined number of real RUB bits containing a sequential number increasing after each four consecutive recording address words.

The invention will now be explained in more detail with reference to the drawings in which:

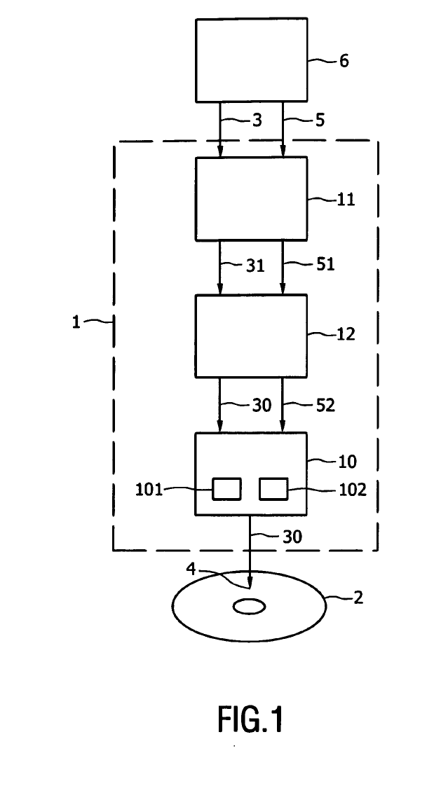

FIG. 1 shows a block diagram illustrating a standard recording device,

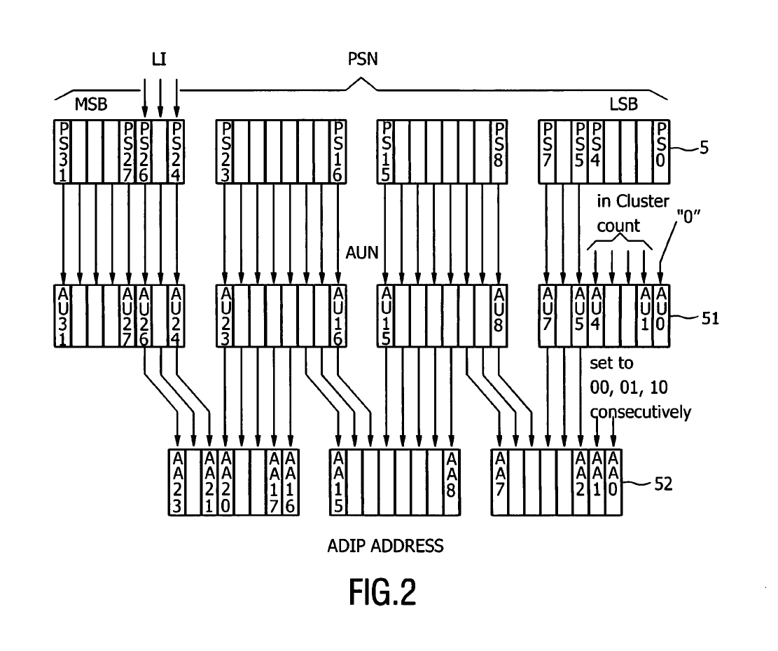

FIG. 2 shows a diagram illustrating the different addresses used in the standard recording method,

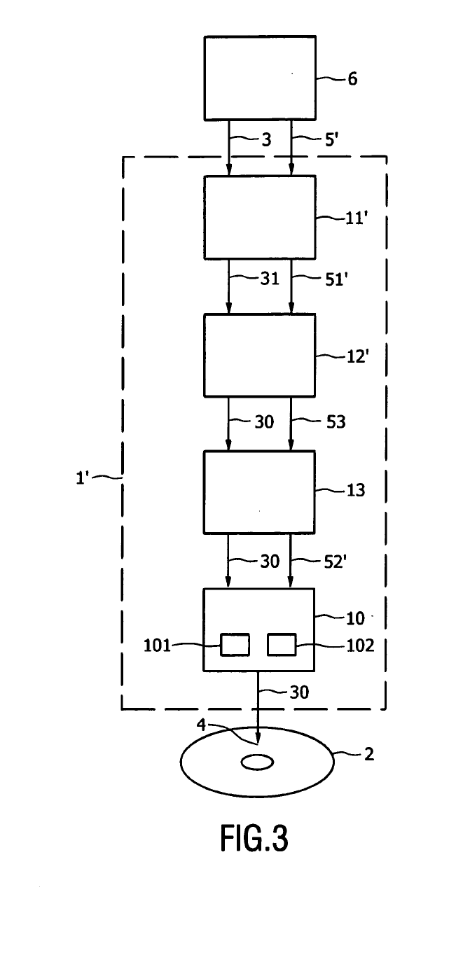

FIG. 3 shows a block diagram illustrating a recording device according to the present invention and

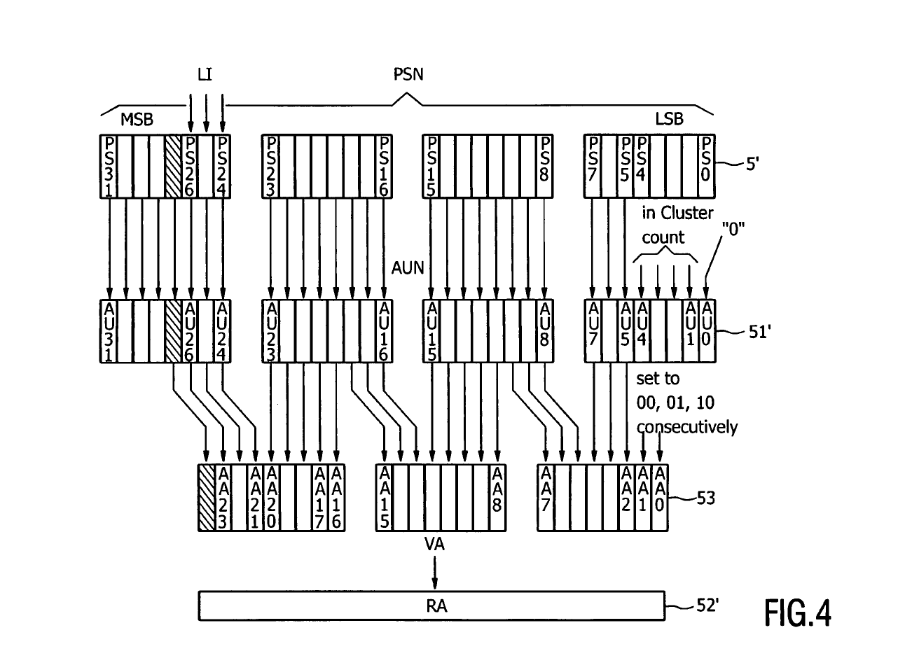

FIG. 4 shows a diagram illustrating the different addresses used in the recording method according to the present invention.

FIG. 1 shows a block diagram of a known recording apparatus 1. Before details of the invention are explained, the standard addressing scheme shall be illustrated using, as an example, the addressing scheme defined in the BD standards.

According to the BD standards there is a pre-groove with a wobble on BD-R and BD-RE discs 2. This sinusoidal mainly monotone wobble contains modulated parts that store address information, in particular ADIP addresses. Each ADIP address contains 24 bits of which the assignments have been explained above.

Recording of user data 3 provided by an application 6 to the recording device 1 on the disc 2 is done—after data and address conversion—in units called Recording Unit Blocks (RUB) 30 by a recording unit 10. A RUB contains 64K of user data 3 written on the disc 2 with spaces and marks like is usual in optical recording. Each RUB is format-wise sub-divided into 16 units, each having its own Address Unit Number (AUN). Intertwined with this user data Λddress Unit Numbers (ΛUNs) are recorded. In each RUB these ΛUNs are supplementary to the ADIP addresses. The ADIP addresses are located in the embossed disc 2, while the AUNs are located in the RUB intertwined with the user data in a special way, which is of no further relevance for the present invention. To enable a positioning unit 101 to position the writing head 102 of the recording unit 10 on the desired recording position 4, such an ADIP address 52 is provided to the recording unit 10. This all relates to the disc.

User data 3 is written to the disc in 64K blocks, but for the application 6 that asks the drive 1 to write data to the disc 2, which can be an application in a PC environment but also a CE device recording video, the user data 2 consists of sectors of 2K each. So there are 32 user data sectors of 2K in an RUB of 64K. Each of these sectors also has an address, a PSN (Physical Sector Number; also called physical sector address herein) 5. This PSN 5 is never written to the disc 2, but it is a virtual number used by the application 6. The application 6 asks the drive 1 to write data to specific physical sectors. It is up to the drive 1 to determine where on the disc 2 the data belonging to a specific PSN should be written. This is not free to choose, but the PSN relates to the AUN which on its turn relates to the ADIP address as will be explained below.

Thus, the inputted user data 3 and the PSN 5 are received by a first conversion unit 11 which converts the PSN 5 into an AUN 51. These data 31 and AUN 51 are provided to a second conversion unit 12 which intertwines the user data 3 with the AUN 51 to obtain data blocks 30 and also converts the AUN 51 into an ADIP address 52. Further, the data blocks 31 having a size of 2K each are converted into the data blocks 30 having a size of 64K each which are then recorded on the disc 2 in this form.

It shall be noted that the above embodiment is just an exemplary way to implement the invention. There are many implementations possible. In other embodiments the recording address can be determined first from the PSN, in a separate circuit and the intertwining can be done in other circuits. So the FIGS. 1 and 3 are just one type of embodiment of such a drive. Furthermore, the invention can also be used for reading data from a record carrier, for instance from a ROM disc.

The relationship between PSN, AUN and ADIP address shall be explained a bit more with reference to FIG. 2. First of all, looking at the PSN, there are in principle 32 bits available. But PS31 to PS27 are reserved and not used according to the BD standard. PS26 to PS24 are used as layer indicator LI to indicate the layer number on the disc where to record the data. PS23 to PS0 are the bits used to indicate the different sectors of 2K on a layer.

Each RUB is format-wise divided into 16 units, each having its own address. So per RUB 16 different ΛUNs are needed. Since there are 32 sectors in a RUB and 16 units in a RUB, each unit will contain 2 sectors of user data. If the AUN needs to count “in step” with the PSN then each successive AUN should increase with two as follows:

| | | | | | |
|---|---|---|---|---|---|
| PSN | 1 | 2 | 3 | 4 | 5 |
| AUN | 1 | | 3 | | 5 etc. |

That is why in FIG. 2 ΛU0 is set to zero, so that the numbers increase with two each successive time. AU4 to AU1 are 4 bits which count the 16 AUNs in a RUB (=cluster). PS4 to PS0 are 5 bits which count the 32 sectors in a RUB. For sector 33 a new RUB has to be used. That is when PS5 changes, this makes AU5 change as well, indicating the next RUB from which AU4 to AU1 start counting again from 0 to 15 etc. . . .

This explains the link between the application and the data to be written together with its AUNs. Now the location where to write on the disc needs to be determined. This is where the ADIP address gets important. There are 3 ADIP words per RUB. These are counted by ΛΛ1 and ΛΛ0, by setting them to 00, 01, and 10 consecutively. The remaining bits AA23 to AA2 are the same within a RUB. They are repeated 3 times in each ADIP word. They indicate the real location and have the link to the AUNs and PSNs as shown in FIG. 2.

As far as the PSN and AUN are concerned enough bits are thus available since there are 5 bits still reserved which can be used to extend the capacity. In the ADIP address, however, only 19 bits are available for addressing which is not enough to increase the capacity beyond 32.2 GB.

A block diagram of a recording apparatus 1′ according to the present invention is shown in FIG. 3. What has been changed compared to the known method and device is that one of the reserved bits, for instance PS27 and AU27 of the reserved bits in the PSN and AUN, respectively, and made available for addressing. This is enough to go well beyond 32.2 GB to what is physically possible.

Thus, the PSN 5′ and the AUN 51′ as well as the conversion units 11′ and 12′ are more or less identical to the PSN 5, the AUN 51 and the conversion units 11 and 12, respectively, except for that additional bit that is used. However, now the AUN 51′ is not directly converted to an ADIP address 52′, but in the conversion unit 12′, also called virtual address determination unit, a virtual address (VA) 53 is determined first. This virtual address 53 is thereafter in a third conversion unit 13, also called recording address determination unit, converted into the recording address (RA) 52′, which corresponds to the ADIP address 52 and which is also provided on the disc 2.

For the addressing on the disc now the bit setting of 11 for the two bits AA0 and AA1 of the recording address 52′ is also allowed. As shown in FIG. 4 in between the RA 52′ and the AUN 51′ the virtual address (VA) 53 has been introduced, a VA 53 consisting of virtual RUB bits VRUB and virtual ADIP bits VADIP. The VRUB has an extra bit VAA24, and the VADIP can, as before in the ADIP address 52 the ADIP bits AA0 and AA1, only be set to 00, 01 or 10.

In such way the relation between the VΛ, ΛUN and PSN is the same as it was before. (except for the one reserved bit with is used now). From the application point of view all can remain as is. Only the application 6, of course, needs to realize that PS27 is now open for addressing as well and not longer reserved, which is a small change. The drive 1′ also needs to know that AU27 has meaning now, which is also a minor change. Furthermore, the drive 1′ needs to know the mapping between VA and RA so that it can find the correct location on the disc 2.

The concept of the present invention can also be illustrated by use of a very simple example, the extension to BD will then be straightforward. Supposing a system where instead of 19 bits for addressing only 2 bits are available. The following ADIP bits can then be introduced:

AA3,AA2: these 2 bits shall contain a sequential number, which number shall increase by one after each 3 consecutive ADIP words (synchronized to the RUBs);
AA1,AA0: these 2 bits shall be set to 00, 01 and 10 consecutively in the 3 successive ADIP words corresponding to one RUB. The setting 11 is reserved and shall not be used.

So in the disc the following sequence of addresses is embossed:

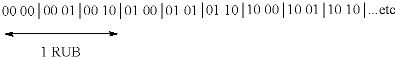

The first two bits are AA3, AA2 and the last two bits of such 4 bit address is AA1,AA0. Addresses are separated by “|”.

Supposing now that a similar problem on such disc exists, i.e. that not enough addresses are available for higher densities. The proposed solution comprises two steps.

Change the ΛΛ1,ΛΛ0 bit sequence to allow for bit setting 11. In this way the full 4 bits are efficiently available on the disc. The disc will look like:

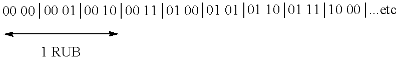

It shall be remarked that a RUB still fits in 3 successive ADIP addresses.

To make sure that the disc can still be correctly addressed, now a virtual address VΛ is introduced consisting of 5 bits (VΛ4 to VΛ0), 3 bits for virtual RUB (VRUB) numbering and 2 bits for virtual ADIP (VADIP) numbering within each VRUB.

VA4, VA3, VA2: these shall contain a sequential number, which number shall increase by one after each 3 consecutive VADIP words. These 3 bits identify the VRUB;
VA1, VA0: these 2 bits shall be set to 00, 01 and 10 consecutively in the 3 successive VADIP words corresponding to one VRUB. The setting 11 is reserved and shall not be used.

In this way the addressing from the application down to the disc does not change except for the introduction of one extra bit to indicate the VRUB. The 3 consecutive VADIP also are addressed like 00, 01, 10 . . . like it used to be in the previous format.

So the application addresses the disc with a VRUB and a VADIP number. From such a combination of VRUB and VADIP, through a mapping the RA needs to be determined on the disc where recording of the actual RUB has to be started. This mapping can be derived by looking at the following table:

| | |
|---|---|
| | 4 bits of |
| 5 bits of virtual address VA | recording address RA |

| VRUB | VADIP | RA |
|---|---|---|
| 000 (0) | 00 (0) | 00 00 (0) |
| 000 (0) | 01 (1) | 00 01 (1) |
| 000 (0) | 10 (2) | 00 10 (2) |
| 001 (1) | 00 (0) | 00 11 (3) |
| 001 (1) | 01 (1) | 01 00 (4) |
| 001 (1) | 10 (2) | 01 01 (5) |
| 010 (2) | 00 (0) | 01 10 (6) |
| 010 (2) | 01 (1) | 01 11 (7) |
| 010 (2) | 10 (2) | 10 00 (8) |
| 011 (3) | 00 (0) | 10 01 (9) |
| 011 (3) | 01 (1) | 10 10 (10) |
| 011 (3) | 10 (2) | 10 11 (11) |
| . . . | . . . | . . . |

The numbers in brackets indicate the decimal equivalent of the binary value.

It is clear from the table that the following mapping will be needed:

RA=VRUB*3+VADIP

And the inverse mapping:

VRUB=Floor[RA/3]

VADIP=Remainder[RA/3]=RA−3*VRUB

The extension to the BD format is now straightforward. Instead of 2 bits 19 bits are available in the current situation. For the VRUB 20 bits are used, and the VADIP remains at 2 bits, with setting 11 reserved. The RA consists of 21 bits, 2 real ADIP bits (RΛDIP) with setting 11 allowed and 19 real RUB bits (RRUB) which is a serial number increasing after each four consecutive recording address words. The mapping remains exactly the same as in the simple example.

In FIG. 4 the hatched blocks indicate a previously reserved bit that has become active to make sure that 20 bits are now available for VRUB addressing. Of course, also any other one of the reserved bits can be used for this purpose. The proposed invention thus provides a simple, easily implementable method for increasing the addressable capacity on a record carrier.

It must further be noted that the term “comprises/comprising” when used in this specification, including the claims, is taken to specify the presence of stated features, integers, steps or components, but does not exclude the presence or addition of one or more other features, integers, steps, components or groups thereof. It must also be noted that the word “a” or “an” preceding an element in a claim does not exclude the presence of a plurality of such elements. Moreover, any reference signs do not limit the scope of the claims; the invention can be implemented by means of both hardware and software, and several “means” may be represented by the same item of hardware. Furthermore, the invention resides in each and every novel feature or combination of features.

The invention can be summarized as follows. Current BD specification prescribes the following format for the ADIP: 24 bits, 3 of which to indicate the layer number, 19 for the RUB number, and 2 to be set to 00, 01 and 10 consecutively in the 3 successive ADIP words corresponding to one RUB. A RUB is the smallest partition of data, namely 64K, that can be written on the disc. From this it derives that at most 32.2 GB of storage space can be addressed. Due to recent developments however, a storage capacity of 35 GB per layer could be achieved.

A slight modification of the ADIP format is proposed, so as to allow an extension of the addressing space: the setting 11 for the two least significant bits is allowed, while the 19 bits no longer represent the RUB number. A drive will nevertheless convert the ADIP into a RUB number and vice versa, in a way which is transparent to a host device or application program.

1. Drive for reading and/or recording user data (3) at a physical sector address (PSN) on a record carrier (2), said record carrier being provided with recording addresses (RA), comprising:
a) an access unit (10) for reading and/or recording said user data on the record carrier (2), and
b) an address conversion unit (11′, 12′, 13) for converting said physical sector address (PSN) into a recording address (RΛDIP) used by said access unit (10) for reading and/or recording user data at said recording address on the record carrier (2), said address conversion unit including
b1) a virtual address determination unit (11′, 12′) for converting said physical sector address (PSN) into a virtual address (VA),
wherein three virtual address words are assigned to one recording unit block (RUB) of data and wherein a virtual address word comprises two virtual ADIP bits (VADIP) set to 00, 01 or 10 indicating the position of said virtual address words in the sequence of the three virtual address words assigned to one recording unit block (RUB) and a predetermined number of virtual RUB bits (VRUB) containing a sequential number increasing after each three consecutive virtual address words, and
b2) a recording address determination unit (13) for converting said virtual address (VA) into said recording address (RA).

2. Drive as claimed in claim 1, wherein a recording address word of said recording addresses (RA) comprises two real ADIP bits (RADIP) set to 00, 01, 10 or 11 and a predetermined number of real RUB bits (RRUB) containing a sequential number increasing after each four consecutive recording address words.

3. Drive as claimed in claim 2, wherein a virtual address word comprises 20 virtual RUB bits (VRUB) and wherein a recording address word comprises 19 real RUB bits (RRUB).

4. Drive as claimed in claim 1, wherein said virtual address determination unit (11′, 12′) comprises:
a first subunit (11′) for converting said physical sector address (PSN) into an address unit number (ΛUN) and
a second subunit (12′) for converting said address unit number (AUN) into a virtual address (VA).

5. Drive as claimed in claim 1, wherein said physical sector addresses (PSN) comprise a physical layer number indicator (LI), in particular three layer indicating bits, indicating one of a plurality of recording layers of a multi-layer record carrier, in which said user data shall be recorded or read, and wherein said address conversion unit (11′, 12′) is adapted for converting said physical layer number indicator into a virtual layer number indicator included in said virtual addresses (VA).

6. Drive as claimed in claim 1, wherein said recording address determination unit (13) is adapted for converting said virtual address (VA) into said recording address (RA) by multiplying the value of said virtual RUB bits (VRUB) by a factor of three and adding the result to the value of said virtual ADIP bits (VADIP).

7. Record carrier carrying recording addresses (RΛ) used by a drive (1′) for reading and/or recording user data (3) on said record carrier, wherein a recording address word comprises two real ADIP bits (RADIP) set to 00, 01, 10 or 11 and a predetermined number of real RUB bits (RRUB) containing a sequential number increasing after each four consecutive recording address words.

8. Record carrier as claimed in claim 7, wherein said a recording address word comprises 19 real RUB bits (RRUB).

9. Record carrier as claimed in claim 7, wherein said recording addresses (RA) are embossed or stored in a secondary channel on the record carrier (2), in particular stored in wobbling of a pre-groove of the record carrier.

10. Method for reading and/or recording user data (3) at a physical sector address (PSN) on a record carrier (2), said record carrier being provided with recording addresses (RA), comprising the step of:
converting said physical sector address (PSN) into a recording address (RADIP) used for reading and/or recording user data at said recording address on the record carrier, said address conversion step including
a first conversion step of converting said physical sector address (PSN) into a virtual address (VA),
wherein three virtual address words are assigned to one recording unit block (RUB) of data and wherein a virtual address word comprises two virtual ADIP bits (VADIP) set to 00, 01 or 10 indicating the position of said virtual address words in the sequence of the three virtual address words assigned to one recording unit block (RUB) and a predetermined number of virtual RUB bits (VRUB) containing a sequential number increasing after each three consecutive virtual address words, and
a second conversion step of converting said virtual address (VA) into said recording address (RA) by multiplying the value of said virtual RUB bits (VRUB) by a factor of three and adding the result to the value of said virtual ADIP bits (VADIP).

11. Drive for reading and/or recording user data (3) at a physical sector address (PSN) on a record carrier (2), said record carrier being provided with recording addresses (RA), comprising:
a) an access unit (10) for reading and/or recording said user data on the record carrier (2), and
b) an address conversion unit (11′, 12′, 13) for converting said physical sector address (PSN) into a recording address (RADIP) used by said access unit (10) for reading and/or recording user data at said recording address on the record carrier (2), wherein a recording address word of said recording addresses (RA) comprises two real ADIP bits (RADIP) set to 00, 01, 10 or 11 and a predetermined number of real RUB bits (RRUB) containing a sequential number increasing after each four consecutive recording address words.

12. Method for reading and/or recording user data (3) at a physical sector address (PSN) on a record carrier (2), said record carrier being provided with recording addresses (RA), comprising the step of: converting said physical sector address (PSN) into a recording address (RADIP) used for reading and/or recording user data at said recording address on the record carrier (2), wherein a recording address word of said recording addresses (RA) comprises two real ADIP bits (RADIP) set to 00, 01, 10 or 11 and a predetermined number of real RUB bits (RRUB) containing a sequential number increasing after each four consecutive recording address words.
